(19) United States
(12) Patent Application Publication
(10) Pub. No.: US 2018/0367712 A1
(43) Pub. Date: Dec. 20, 2018

(54) CAMERA HOUSINGS HAVING TACTILE CAMERA USER INTERFACES FOR IMAGING FUNCTIONS FOR DIGITAL PHOTO-VIDEO CAMERAS

(71) Applicant: MOHOC, Inc., Seattle, WA (US)

(72) Inventors: Connor J. Duncan, San Francisco, CA (US); Daniel S. Fuhrman, Ketchum, ID (US); John M. Prosser, Mays Hill (AU); Eric Andrew Dobbie, Ketchum, ID (US)

(73) Assignee: MOHOC, Inc., Seattle, WA (US)

(21) Appl. No.: 15/854,286

(22) Filed: Dec. 26, 2017

Related U.S. Application Data
(63) Continuation of application No. 14/716,379, filed on May 19, 2015, now abandoned.
(60) Provisional application No. 62/000,151, filed on May 19, 2014.

(51) Int. Cl. H04N 5/225; G06F 1/16; G06F 3/0362; G06F 3/02; G06F 3/0487; G06F 3/01

(52) U.S. Cl. CPC H04N 5/2252; G06F 1/163; G06F 3/0362; G06F 3/016; G06F 3/0487; G06F 3/0202

(57) ABSTRACT

Easy-to-use, limited function tactile camera user interfaces for imaging-related functions for digital photo-video cameras.

### CROSS-REFERENCE TO RELATED APPLICATIONS

The present application claims the benefit of copending U.S. Provisional Patent Application Ser. No. 62/000,151 entitled “LOW PROFILE CAMERA HOUSINGS HAVING CONCLAVELY CURVED BASE SURFACES AND RELATED SYSTEMS AND METHODS”, filed May 19, 2014, which application is incorporated herein by reference in its entirety.

The aspects and embodiments within this application are well suited to low profile camera housings as discussed and/or claimed in the provisional application cited above as well as U.S. patent application Ser. No. ______ entitled “LOW PROFILE CAMERA HOUSINGS HAVING CONCLAVELY CURVED BASE SURFACES AND RELATED SYSTEMS AND METHODS”, filed May 19, 2015, attorney Reference No.: 3094-001-03 and Patent Cooperation Treaty Application No. entitled “LOW PROFILE CAMERA HOUSINGS HAVING CONCLAVELY CURVED BASE SURFACES AND RELATED SYSTEMS AND METHODS”, filed May 19, 2015, attorney Reference No.: 3094-001-04, both of which are incorporated herein in their entirety, and thus the discussion herein will primarily address such low profile camera housings, and in particular wearable versions of such camera housings suitable for wear on a helmet, shoulder or other surface of a military or first responder user. Nevertheless, the aspects and embodiments discussed in this application apply also to other camera housings unless the context herein expressly states that a particular aspect or embodiment applies only to low profile camera housings; such embodiments provide advantages over other camera housings, for example because the ability to complement the low-profile, discreet nature of such camera housings to avoid attracting attention of unwanted persons such as enemy combatants.

### BACKGROUND

There has gone unmet a need for improved devices, systems and methods that can provide very easy-to-use, limited function user-interface switch(es) that simplify camera use, eliminate non-critical choices for the user and/or can be used based solely on tactile interaction with the camera, including but not limited to situations such as extreme sports, military and/or first-responder environments.

The present devices, systems and methods, etc., provide one or more of these and/or other advantages.

### SUMMARY

The present systems, devices and methods, etc., provide very easy-to-use, limited function tactile camera user interfaces for imaging-related functions for digital photo-video cameras. As noted above, the discussion herein will primarily address low profile camera housings, and in particular wearable versions of such camera housings suitable for wear on a helmet, shoulder or other surface of a military or first responder user. Nevertheless, the aspects and embodiments discussed in this application apply also to other camera housings unless the application or claims expressly state that a particular aspect or embodiment applies only to low profile and/or concavely curved camera housings.

In one aspect, the present systems, devices and methods, etc., provide outer (i.e., external) tactile camera user interfaces for imaging-related functions for digital photo-video cameras (i.e., digital cameras that have both photo and videos image capture modes) wherein the outer tactile camera user interface is located on an outer surface of a camera housing and eliminates non-critical choices for the user. The outer tactile camera user interface is structured such that all functions implemented by the outer tactile camera user interface can be selected manually (i.e., without visual interaction between the user and external tactile camera user interface). “External tactile camera user interface” as used herein means a tactile camera user interface located on at least one external surface of the camera housing; if desired, the camera housing can also include at least one external or internal user interface that includes visually-based interaction between the user and the camera. “Tactile” as used herein indicates a user interface device configured to be implemented by mechanically moving the interface device using the hand(s) of a user, for example by twisting or rotating a knob, toggle or rotary tab and/or by pushing a button.

In certain embodiments, the external tactile camera user interface consists of a single operational element such as a depressible toggle or switch. Also in some embodiments, the external surface of the camera housing consists essentially of the external tactile camera user interface as discussed herein (i.e., the only user interface on the external surface of the camera housing is the tactile camera user interface herein, although the external surface of the camera housing may have other operational elements), while in still further embodiments the external surface of the camera housing consists solely of the external tactile camera user interface as discussed herein (i.e., the only user interface on the external surface of the camera housing is the image-control tactile camera user interface herein, although the external surface of the camera housing may have non-user interface elements such as access buttons or clips allowing access to the interior of the camera housing).

In some embodiments, the external tactile camera user interface comprises no display screens or light-emitting elements and in some other embodiments, the entire external surface of the camera housing, including all external user interfaces, comprises light-emitting elements and/or no solely visually-based user interface elements such as display screens (e.g., LED screens, LCD screens, etc.). In some embodiments, the camera housing comprises an “off switch” that universally disables all light-emitting elements and/or solely visually-based user interface elements that might be found on the external surface to avoid unintentional emissions of light.

In still further embodiments, the external tactile camera user interface consists of a single control element such as a toggle or a switch with a depressible button. The external tactile camera user interface can also consist of solely three positions: 1) an off position that turns off at least all immediate proximity user-operated functions of the camera (i.e., functions controlled by the wearer or other person able to physically touch the user interface) and typically all user-controlled functions whether such functions are controlled by a proximate user or a remote entity; 2) a photo position that permits user-acquisition of still photographs, such as by depressing a button; if desired this position 2) can also activate internal elements of the camera such that the camera can communicate with remote entities such as via Wi-Fi, 4G capable elements, Bluetooth® or satellite (whether directly or directly) and if desired can be controlled remotely by such remote entities (such control can be complete control of all functions including video acquisition or partial control such as only those functions active for the user in the “photo” position; in such remote-control embodiments, the “photo” position can be considered an “on” position but without necessarily taking images); and 3) an “image capture” position wherein setting the external tactile camera user interface to such position activates image continuous capture such that the image sensor begins and continues recording (i.e., no further activation is required to have the sensor acquire regular video, high-speed video, time lapse video/photos, etc.); in “image capture” position 3, the images can be automatically captured until the tactile user interface is physically switched to one of the other positions.

In certain embodiments, the camera, camera housing and tactile user interface system is simplified such that all focus, imaging characteristics (ISO, f-stop, pixel count, video rates, etc., are entirely predetermined such as via use of single focus lens and image quality systems, or by permitting variations of such features solely through internal user interfaces (which internal user interfaces may comprise display screens) contained within the camera housing. In further embodiments,

[symbol]

These and other aspects, features and embodiments are set forth within this application, including the following Detailed Description and attached drawings. In addition, various references are set forth herein, including in the Cross-Reference To Related Applications, that discuss certain systems, apparatus, methods and other information; all such references are incorporated herein by reference in their entirety and for all their teachings and disclosures, regardless of where the references may appear in this application.

### BRIEF DESCRIPTION OF THE DRAWINGS

FIG. 1 depicts a side elevational view of an exemplary camera unit comprising a limited function tactile camera user interface as discussed herein.

FIG. 2 depicts a front view of an exemplary camera unit comprising limited function tactile camera user interface as discussed herein.

FIG. 3 depicts a rear view of an exemplary camera unit comprising limited function tactile camera user interface as discussed herein.

FIG. 4 depicts a side view of an exemplary low profile concavely camera unit suitable for use with a limited function tactile camera user interface as discussed herein, attached to a military-level helmet.

FIG. 5 depicts a front view of an exemplary low profile concavely curved camera unit suitable for use with a limited function tactile camera user interface as discussed herein, attached to a military-level helmet.

FIG. 6 depicts a side plan view of an exemplary camera unit comprising a limited function tactile camera user interface as discussed herein attached to a kayak.

FIG. 7 depicts a top plan view of an exemplary camera unit comprising a limited function tactile camera user interface as discussed herein attached to a kayak.

FIG. 8 depicts a side view of an exemplary camera unit comprising a limited function tactile camera user interface as discussed herein attached to a helmet and to a shoulder pad of a soldier.

FIG. 9 depicts a side view of an exemplary camera unit comprising a limited function tactile camera user interface as discussed herein attached to a left side of a military-level helmet.

FIG. 10 depicts a top plan view of a camera housing comprising a top-mounted toggle switch as the limited function tactile camera user interface as discussed herein.

FIG. 11 depicts a perspective view of a camera housing comprising a top-mounted toggle switch as the limited function tactile camera user interface as discussed herein.

FIG. 12 depicts a front plan view of a camera housing comprising a top-mounted toggle switch as the limited function tactile camera user interface as discussed herein.

FIG. 13 depicts a side plan view of a camera housing comprising a top-mounted toggle switch as the limited function tactile camera user interface as discussed herein.

FIG. 14 depicts a top plan view of a further embodiment of a camera housing comprising a rear mounted rotary tab as the user interface as discussed herein.

FIG. 15 depicts a rear plan view of a further embodiment of a camera housing comprising a rear mounted rotary tab as the user interface as discussed herein.

FIG. 16 depicts an underneath perspective view of an exemplary low profile concavely curved camera unit suitable for use with the camera user interface user interface as discussed herein.

FIG. 17 depicts an underneath perspective view of a low profile concavely curved camera unit as discussed herein showing a flat base surface.

FIGS. 18A-18D depict flow charts of exemplary embodiments of an exemplary embodiment suitable for use with a 3-position rotary tab as the user interface as discussed herein.

### DETAILED DESCRIPTION

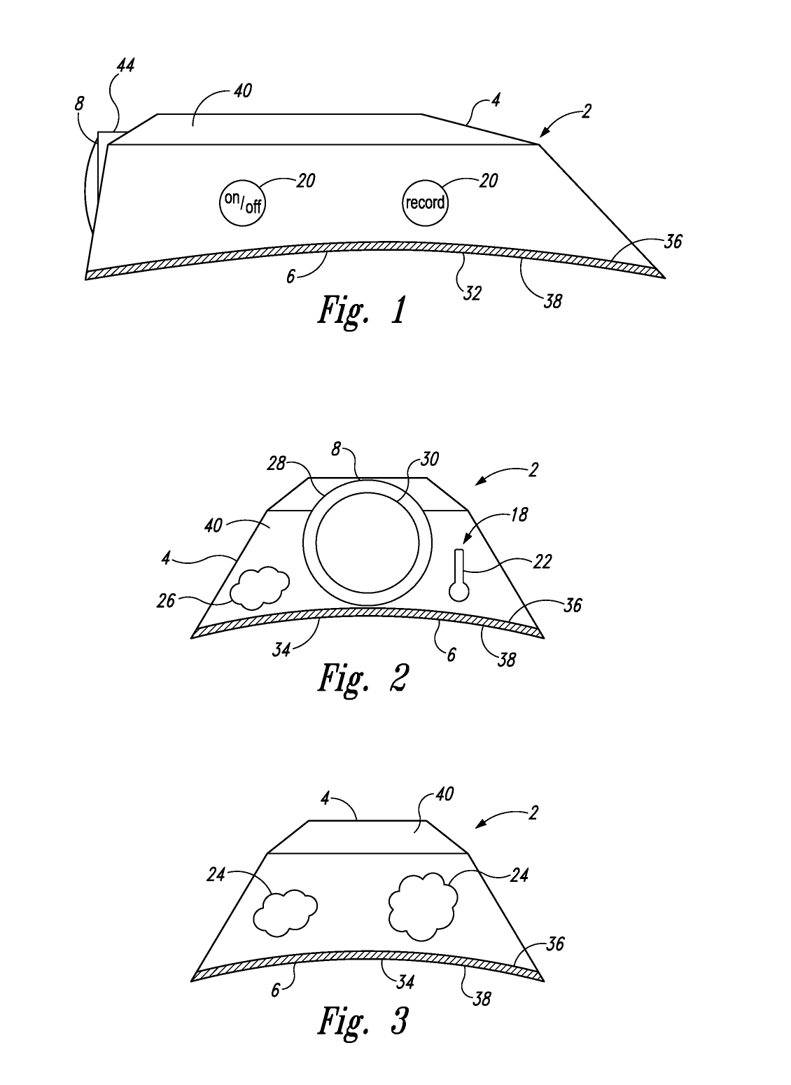

The current devices, systems, methods, etc., are directed to a very simple user interface and user experience (UI/UX) comprising controls. Turning to the figures, FIGS. 1-3 depict side, front and rear views of an exemplary low profile concavely curved camera unit 2. As noted above, the discussion herein will primarily address low profile camera housings, and in particular wearable versions of such camera housings suitable for wear on a helmet, shoulder or other surface of a military or first responder user. Nevertheless, the aspects and embodiments discussed in this application apply also to other camera styles and housings such as SLR cameras, point-and-shoot cameras, sport cameras, etc., unless the application or claims expressly state that a particular aspect or embodiment applies only to low profile and/or concavely curved camera housings.

As seen in FIGS. 1-3, the digital photo-video camera unit 2 comprises a camera housing containing a digital photo-video camera and a camera housing outer surface consisting essentially of an outer tactile camera user interface wherein all image-capture controls of the outer tactile camera user interface are tactile controls requiring mechanical manipulation by a proximate user to select different image capture functions. In FIG. 1, the user interface 16 comprising tactile user interface controls 18 can be located on the left side of the low profile concavely curved camera unit 2, wherein the power on/power off and record functions are controlled by depressable buttons 20. If desired, haptic feedback such as detents, vibrations or pulsed vibrations can provide non-visual information to the user upon manipulation of the depressable buttons 20, for example using different pulse numbers or durations to indicate different switch positions of the tactile user interface.

In FIG. 2, the user interface 16 comprises a single user interface control 18 located on the front of the low profile concavely curved camera unit 2. and wherein all desired functions, for example at least the power on/power off and record images functions, are controlled by a single toggle switch 22. In such an embodiment, the power on/power off and “shoot” can be simultaneously engaged upon activating the control switch 18. In FIG. 3, the user interface 16 comprises knobs 24 located on the rear of the low profile concavely curved camera unit 2.

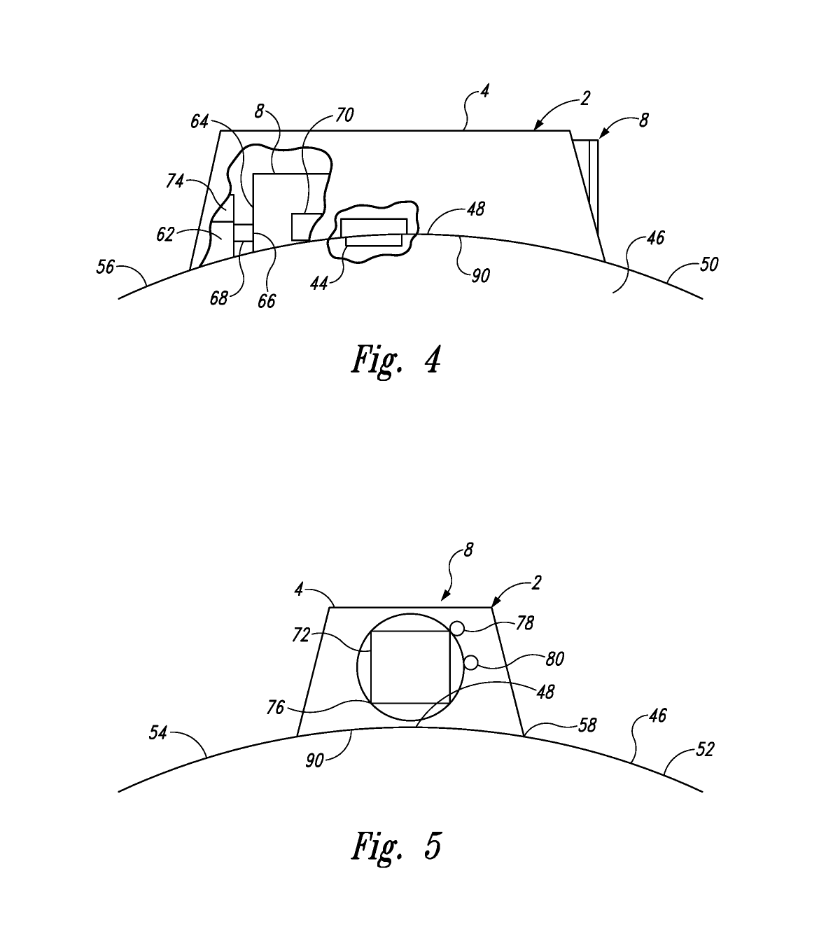

The camera unit 2 comprises a camera housing 4 comprising a concave base surface 6 structured to match a curvature of an upper surface of a convexly curved base substrate such as a military-level helmet (reference number 46 in FIGS. 4-6). Unit 2 also can comprise a single-motion releasable attachment/detachment element 36 structured to releasably attach and detach the concave base surface 6 to and from an upper surface of the military helmet and a smooth, non-snag upper surface 14 of the camera housing 12, and a user interface 16 comprising user interface controls 18 that can be operated by a single hand of a user without visual interaction by the user, even by using only a single hand, which hand can be in a glove such as a glove structured for combat.

FIGS. 1-3 also depict a camera 8 covered by a hood 44 that covers the camera 8 and/or camera lens 30, and provide some exemplary, non-limiting possible dimensions for the low profile concavely curved camera unit 2. The camera 8 can be unitary with other elements of low profile concavely curved camera unit 2, as shown in FIGS. 1-3, or can be discrete as shown in certain other figures.

FIG. 2 also shows an optics control knob 26 that controls a camera housing optical element 28 disposed in front of the camera lens 30. In FIG. 2, the camera housing optical element 28 is structured to be non-distorting such that an image transmitted through the camera housing optical element 28 is substantially undistorted upon reaching camera lens 30 of the camera 8. In this embodiment, the camera housing optical element 28 is also structured to enlarge images passing through the camera housing optical element 28 such that an image transmitted through the camera housing optical element 28 is substantially enlarged a pre-determined amount upon reaching the camera lens 30 or to reduce images passing through the camera housing optical element 28 such that an image transmitted through the camera housing optical element 28 is substantially reduced a pre-determined amount upon reaching the camera lens 30. Optics control knob 26 can be a selector switch structured to select between the enlarged image or the reduced image, and/or other imaging modes as desired. If desired, camera lens 30 can be manually rotated via a tactile user interface relative to at least the camera housing 4.

As can be seen by comparing the different views of FIGS. 1-3, the concave base surface 6 can comprise at least two different radii 32, 34. The concave base surface 6 can be rigid or slightly elastic to moldably conform to varying radiuses encountered on different locations on an upper surface of the helmet as in FIGS. 4-5, discussed later. Also as in FIGS. 1-3, the attachment/detachment element 36 can be a hook-and-loop fabric 38 and the low profile concavely curved camera unit 2 does not include any device that penetrates the helmet, including that low profile concavely curved camera unit 2 does not include any bolts, screws or other attachment devices that compromise the integrity of the underlying helmet.

The low profile concavely curved camera unit 2 can be made of a personnel-protection material 40.

Turning to FIGS. 4-9, such figures depict various embodiments of suitable, exemplary low profile, snag free camera housings suitable for use with the tactile user interfaces discussed herein. In particular, FIGS. 4-5 depict side and front views of a system comprising a military-level helmet 46 and a low profile concavely curved camera unit 2 as discussed herein. The helmet 46 and the unit 2 can be structured to interact cooperatively such that the low profile concavely curved camera unit 2 can be easily and repeatedly attached and detached to different parts of the helmet 46, i.e., to differently curved convex base substrates 90 of the helmet 90. For example, the low profile concavely curved camera unit 2 can be easily and repeatedly attached and detached to each of a top 48, front 50, left side 52, right side 54 and back 56 of the helmet 46.

In FIG. 4, the attachment/detachment element 36 is a pair of powerful magnets 44, shown in cutaway. The magnets 44 can be configured to hold to each other without physically penetrating the base substrate 90. In situations where the base substrate 90 comprises metallic or other magnet-responsive materials, only a single magnet need be used. In FIG. 5, the attachment/detachment element 36 is an adhesive 58. The concave base surface 6 is slightly elastic to moldably conform to varying radiuses encountered on different locations on the upper surface 60 of the helmet 46. In these figures, the helmet is an OPS core fast helmet.

As shown in FIG. 4, the low profile concavely curved camera unit 2 comprises a first plug-in docking element 62 shown in cutaway and configured to dock with a corresponding, second plug-in docking element 64 on camera 8, which camera 8 is discrete from low profile concavely curved camera unit 2 and is also configured to dock with unit 2. The first plug-in docking element 62 and the second plug-in docking element 64 can comprise corresponding male and female members, 66, 68. Exemplary docking elements can be USB or HDMI connections or a hard connection to additional components inside the helmet that do not fit inside the housing, or other items that may desirably docked the camera 8 and/or camera housing 4. The unit 2 also comprises at least one wireless transmitter element 70 structured to send real-time images to remote monitors. The wireless transmitter element 70 can be a wifi transmitter, Bluetooth® transmitter or any suitable other wireless transmitter, particularly sturdy and secure transmitters suitable for combat situations.

The camera housing 4 further can comprise at least one camera housing power source 74 structured to provide power to the camera 8. The camera housing power source 74 can be, for example, a battery such as a lithium battery or any other battery suitable for intense situations such as combat or fighting fires. The camera housing power source 74 can be connected to the camera 8 via a plug-in docking element, which can be the same or a different docking element used to connect the camera housing 4 and its associated elements and devices to the camera 8. Thus, the power docking element can also be first plug-in docking element 62 and second plug-in docking element 64 so long as proper wiring and structure is provided. The camera housing power source can also be a wireless recharger if desired.

As shown in FIG. 5, the camera housing 4 further can comprise at least one camera housing light-enhancement element 72. The camera housing light-enhancement element 72 can comprise at least one filter 76 structured to selectively block or reduce selected wavelengths of light. For example, filter 76 can selectively block at least one of infrared (IR) light, near-infrared (NIR) light, visible light and ultraviolet (UV) light.

The camera housing light-enhancement element 72 can also comprise one or more of a night-vision device 78 or a one camera housing light emitter 80. The camera housing light emitter 80 can be structured to provide any desired light, for example to variably, selectively emit infrared (IR) light, near-infrared (NIR) light, visible light and ultraviolet (UV) light.

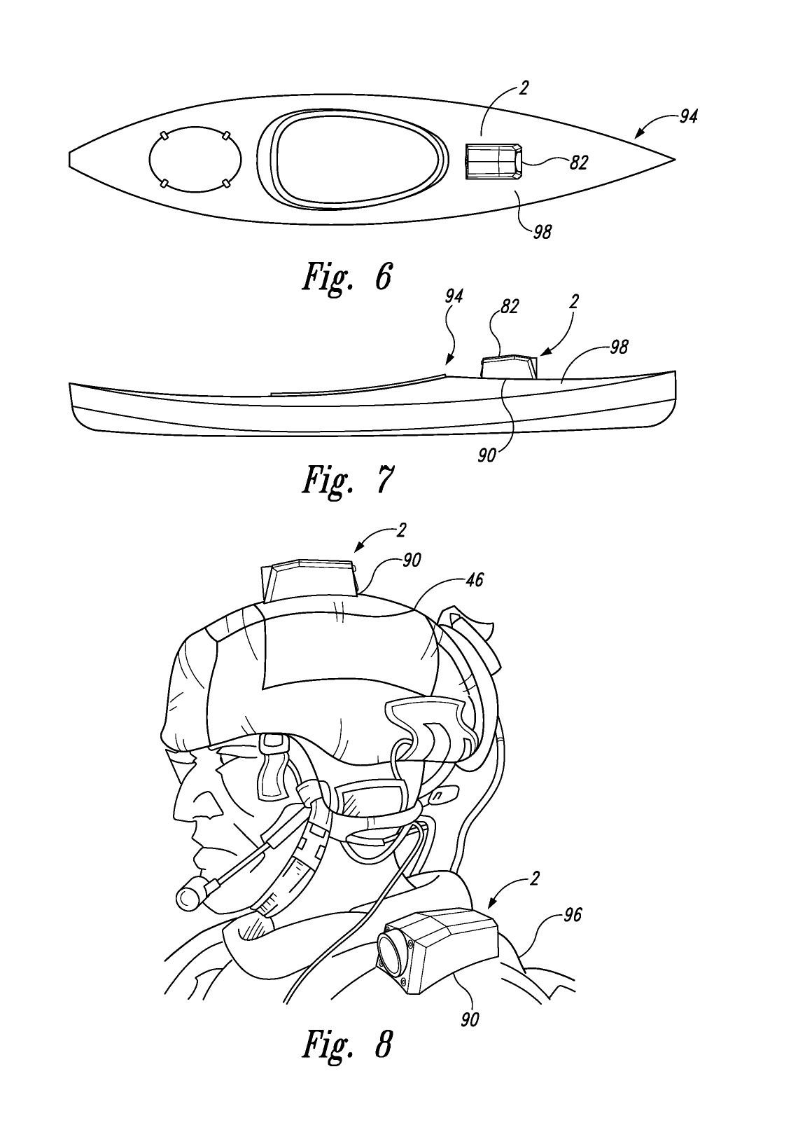

FIGS. 6 and 7 depict exemplary side and top plan views of a mock-up 82 of a low profile concavely curved camera unit 2 as discussed herein attached to the bow 98 of a kayak 94.

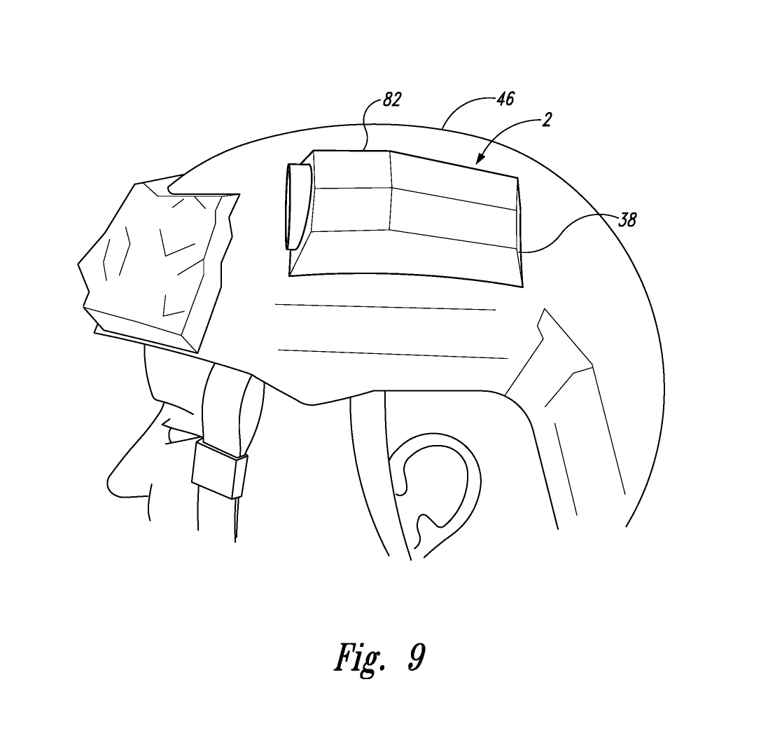

FIG. 8 depicts a side view of low profile concavely curved camera units 2 as discussed herein attached to a helmet 46 and to a shoulder pad 96 of a soldier. The convex base substrate 90 can also be any other desirable base substrate, including gear and machines such as aircraft, vehicles, etc.

FIG. 9 depicts an exemplary front view of a mock-up 82 of a low profile concavely curved camera unit 2 as discussed herein attached to a left side of a military-level helmet 84. FIGS. 4-9 demonstrate the ability of the camera housings 4 herein to adapt to and fit closely to a variety of different, multi-radiused convex base substrates 90 without snag hazards and typically without significant air gaps between the camera housings 4 and the convex base substrates 90.

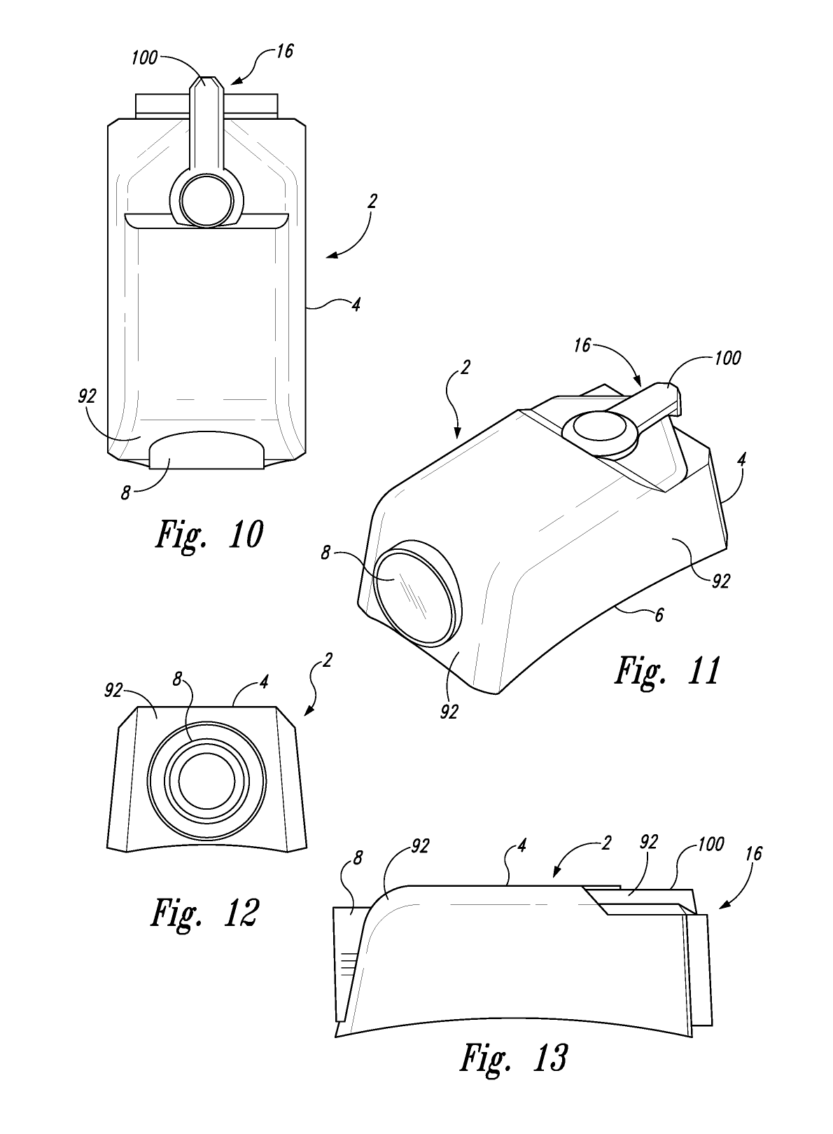

FIGS. 10-13 depict views of a further embodiment of a low profile concavely curved camera unit 2 as discussed herein comprising a top-mounted toggle switch 100 at the user interface 16. In FIGS. 10-13, the camera 8 is discrete from the housing elements 92. “Discrete” as used in this context means that the camera 8 is separate from the camera housing 4 and can be inserted, moved and/or removed as desired. In addition, the camera housing 4 and the camera can be manufactured separately then combined either in a further manufacturing step or in the field or otherwise as desired. The embodiment in FIGS. 10 and 11 also depicts the non-snag aspects of the housing, knobs, etc., applying only to the front, sides and top of the camera housing but not to the back of the camera housing.

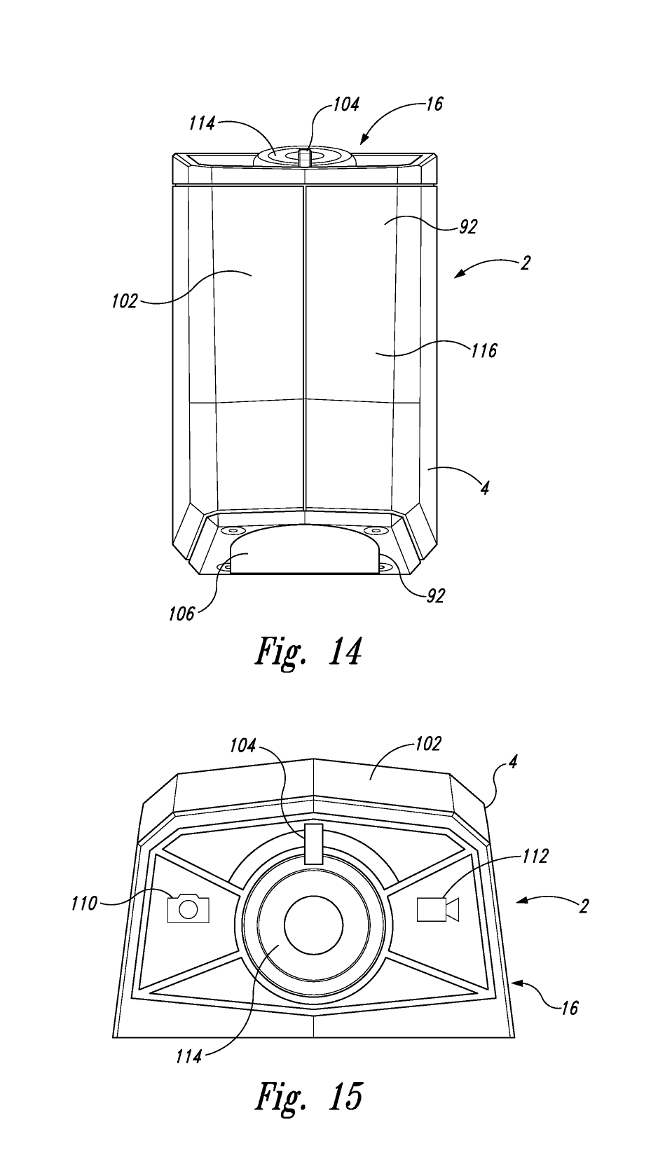

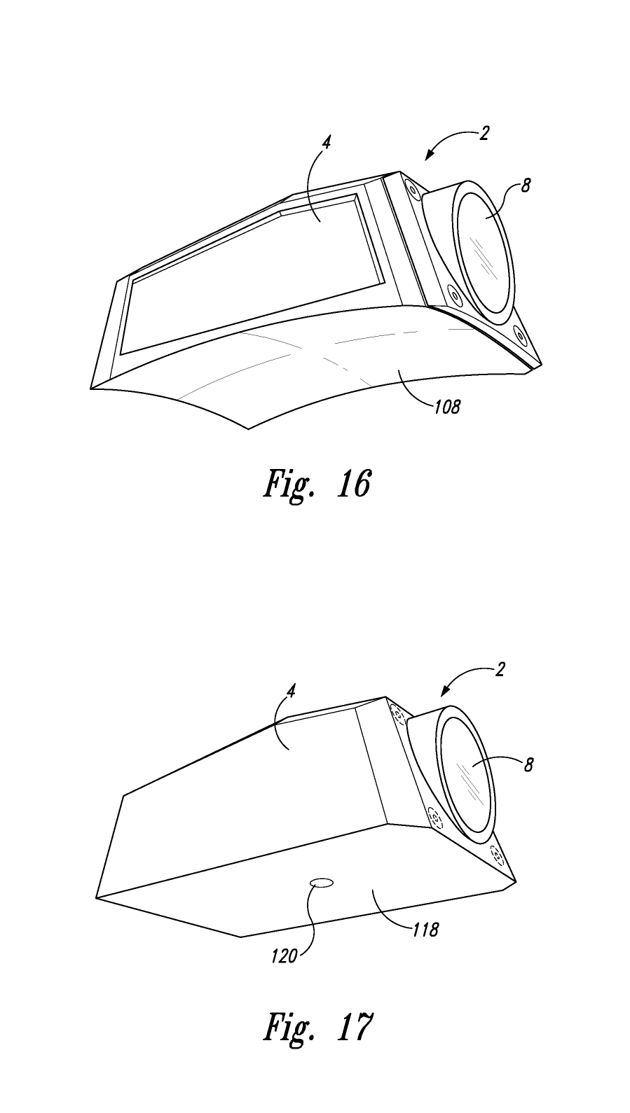

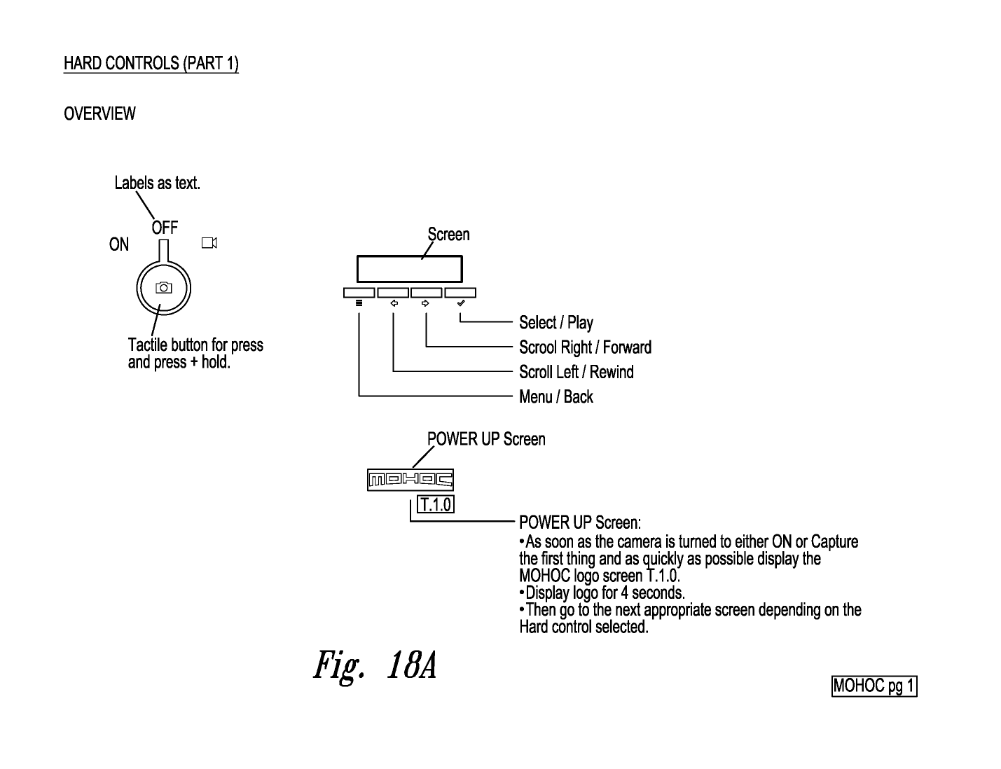

FIGS. 14-15 depict views of a further embodiment of a low profile concavely curved camera unit 2 as discussed herein comprising a rear mounted rotary tab 104 at the user interface 16 and a recessed or flush-mounted camera lens 106 at the front. In FIGS. 14-15, the camera 8 is unitary with the housing elements 92. “Unitary” as used in this context means that at least the shell of the camera 8 and camera housing 4 are made from a single or combined piece(s) of material such that the camera cannot be separately inserted or removed from the housing. Advantageously, the camera housing 4 and the camera 8 contained within it can be manufactured in a single process.

In FIGS. 10-15, the unit 2 including the outer surface 60 of the camera housing 4 and tactile camera user interface 16 comprise no display screens or light-emitting elements and in some other embodiments, the entire external surface of the camera housing, including all external user interfaces, comprises light-emitting elements and/or no solely visually-based user interface elements such as display screens (e.g., LED screens, LCD screens, etc.). In some embodiments, the camera housing comprises a “lights off switch” that universally disables all light-emitting elements and/or solely visually-based user interface elements that might be found on the external surface to avoid unintentional emissions of light.

In FIGS. 14-15, the unit 2 also comprises a recessed panel 102 that permits or assists access to the camera and other inner workings/elements inside the camera housing 4. Recessed panel 102 can be either fixed or depressible. The recess can enhance the ability of users to hold on to the camera housing 4, for example when the camera housing 4 is in-place on a base substrate or when the camera housing 4 is detached from the base substrate. The recessed panel can either be depressed to open up and allow access to inner workings inside the housing, and/or can provide a hold-point so that a user can more easily grasp the camera housing 4 while accessing inner workings through a different access point such as an access door 116.

Also, user interface 16 comprising the rear mounted rotary tab 104 comprises icons for both still photography 110 and video photography 112. In one embodiment, the upright position for rotary tab 104 is the “off” position while moving to either icon both turns on the camera 8 and causes the indicated function to begin working. The on/off of recording/image taking can in turn be controlled remotely or by depressing button 114, or can be automatic upon activation of the rotary tab 104 such that “record images” (whether still images, a series of still images or video) is controlled by a single switch, button or other recording activation element. In one embodiment, as shown in FIG. 15, the user interface comprises at least one depressable button 114 and the user interface is configured such that the camera can be set for a standby mode such that depressing the button during the standby mode causes the camera to begin recording images.

FIG. 16 depicts an underneath perspective view of a low profile concavely curved camera unit 2 as discussed herein showing a multiply-radiused base surface 108.

FIG. 17 depicts an underneath perspective view of a low profile camera unit 2 as discussed herein except that the unit has a flat base surface 108. The camera housing 4 shown in FIG. 17 also includes a bolt hole 120 to receive a bolt or other penetrating attachment element that extends from or through the base substrate (base substrate not shown); the male and female features of such connectors can be reversed if desired, and this feature can likewise be used with concavely curved base surfaces.

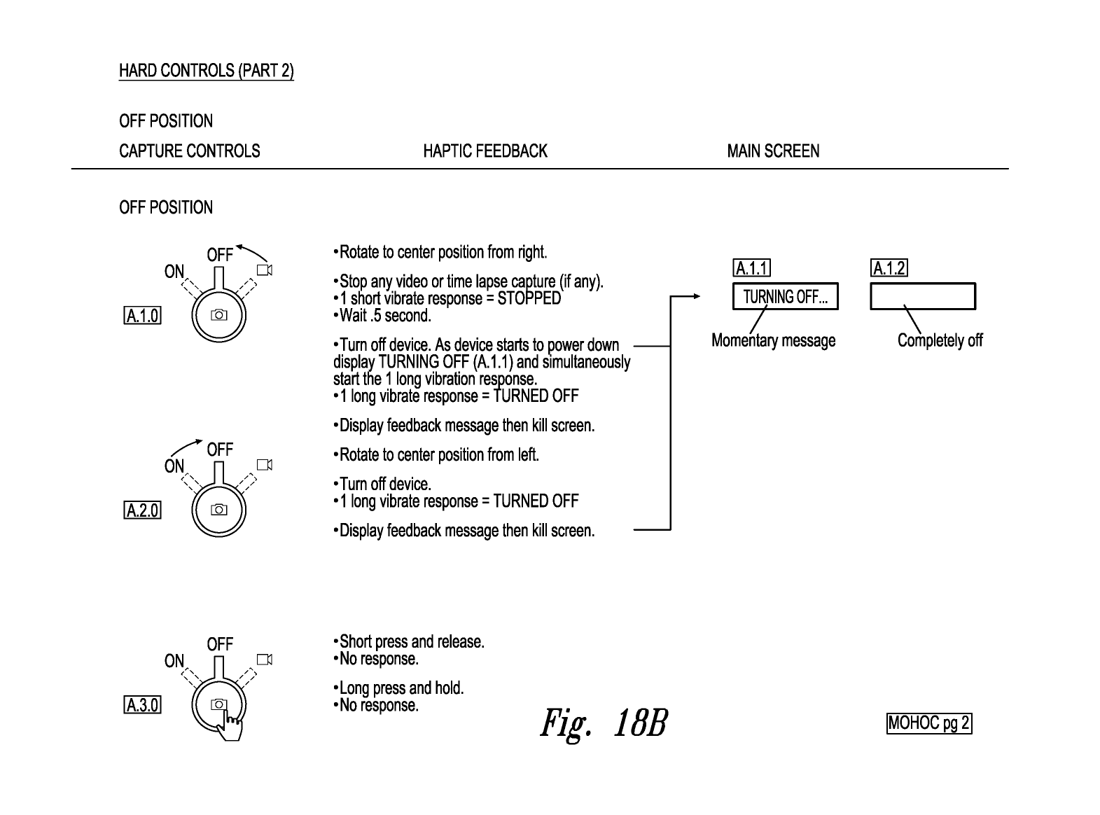

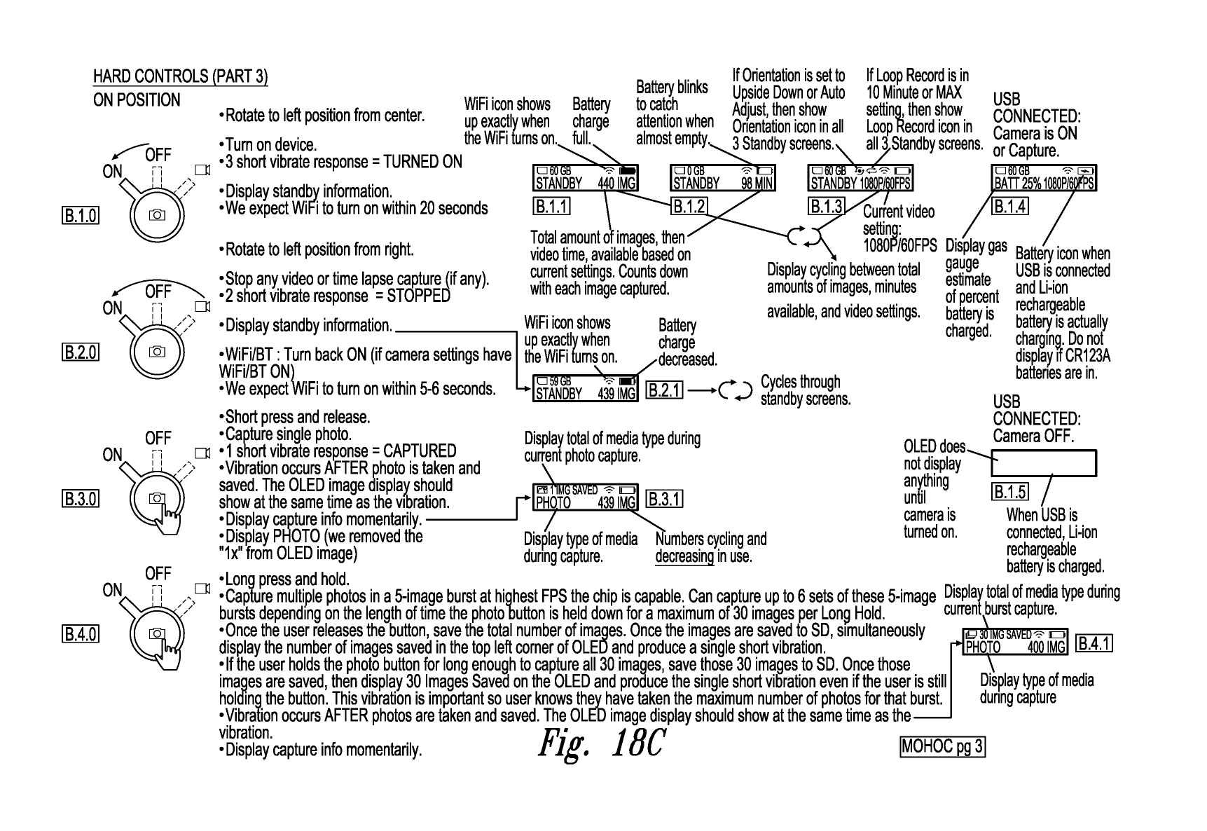

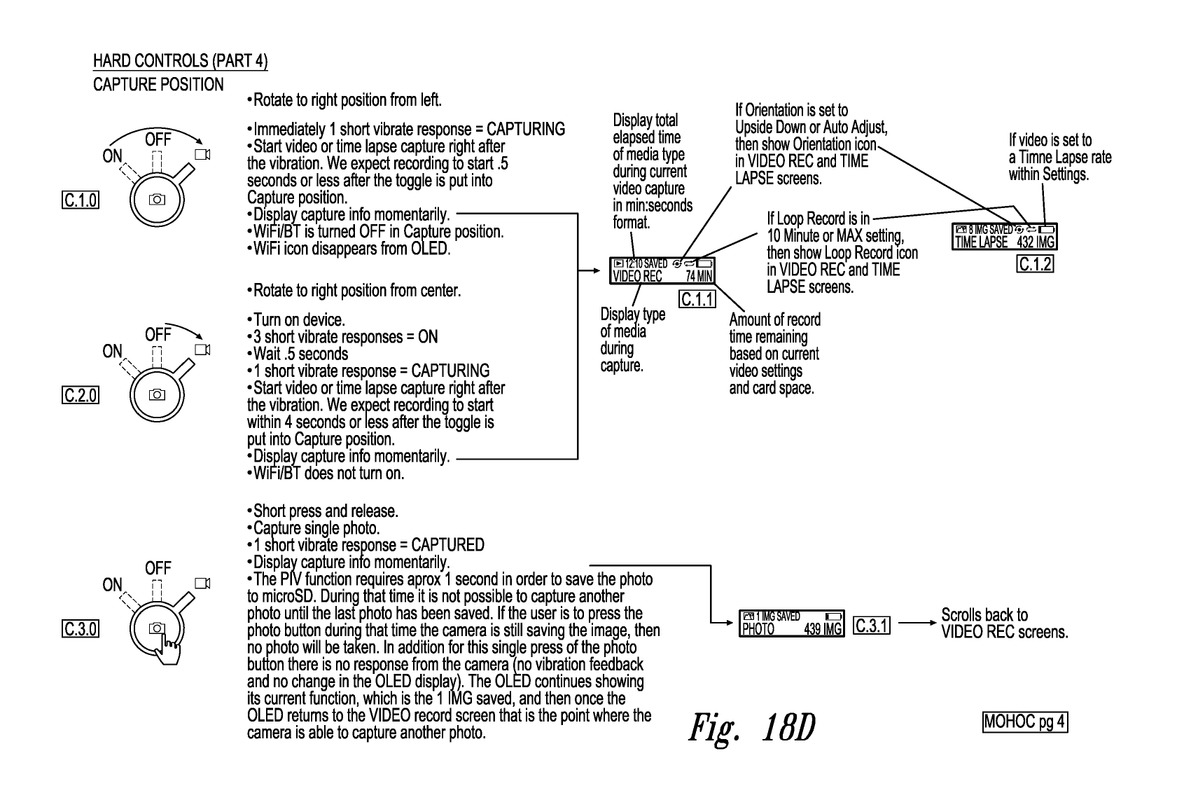

FIGS. 18A-18D depict flow charts of exemplary embodiments of an exemplary flow of actions and information achieved pursuant to moving a 3-position outer tactile camera user interface, in this embodiment a 3-position rotary tab such as the rear mounted rotary tab 104 shown in FIGS. 14-15. As can be seen, this tactile outer user interface consists of solely three positions: 1) an off position that turns off at least all immediate proximity user-operated functions of the camera (i.e., functions controlled by the wearer or other person able to physically touch the user interface) and typically all user-controlled functions whether such functions are controlled by a proximate user or a remote entity; 2) a photo position that permits user-acquisition of still photographs, such as by depressing a button; if desired this position 2) can also activate internal elements of the camera such that the camera can communicate with remote entities such as via Wi-Fi, 4G capable elements, Bluetooth® or satellite (whether directly or directly) and if desired can be controlled remotely by such remote entities (such control can be complete control of all functions including video acquisition or partial control such as only those functions active for the user in the “photo” position; in such remote-control embodiments, the “photo” position can be considered an “on” position but without necessarily taking images); and 3) an “image capture” position wherein setting the outer tactile camera user interface to such position activates image continuous capture such that the image sensor begins and continues recording (i.e., no further activation is required to have the video camera acquire regular video, high-speed video, time lapse video/photos, etc.); in “image capture” position 3, the images can be automatically captured until the tactile user interface is physically switched to one of the other positions.

Turning to a more general discussion of certain aspects, features and embodiments herein, the camera unit comprises a very simple user interface and user experience (UI/UX). The user interface can be snag free and comprises only controls that can be operated by a single hand without visual interaction by the user and while wearing gloves. In some embodiments, the user interface comprises a single control switch that controls essential operations of the camera such as power on/power off and “record”, e.g., (i.e., “shoot” in video camera mode or “shoot” in photo mode). The power on/power off and “shoot” can be simultaneously engaged if desired, e.g., turning on the power automatically causes the video camera to start recording and turning off the power automatically causes the video camera to stop recording.

The control switch can be, for example a depressible button, a toggle switch, a knob, or any other easily manipulated control device, and the control switch can be placed so that it is easily located by a user and can be selectively operated by tactile feedback.

All terms used herein are used in accordance with their ordinary meanings unless the context or definition clearly indicates otherwise. Also unless expressly indicated otherwise, in the specification the use of “or” includes “and” and vice-versa. Non-limiting terms are not to be construed as limiting unless expressly stated, or the context clearly indicates, otherwise (for example, “including,” “having,” and “comprising” typically indicate “including without limitation”). Singular forms, including in the claims, such as “a,” “an,” and “the” include the plural reference unless expressly stated, or the context clearly indicates, otherwise.

The scope of the present devices, systems and methods, etc., includes both means plus function and step plus function concepts. However, the claims are not to be interpreted as indicating a “means plus function” relationship unless the word “means” is specifically recited in a claim, and are to be interpreted as indicating a “means plus function” relationship where the word “means” is specifically recited in a claim. Similarly, the claims are not to be interpreted as indicating a “step plus function” relationship unless the word “step” is specifically recited in a claim, and are to be interpreted as indicating a “step plus function” relationship where the word “step” is specifically recited in a claim.

From the foregoing, it will be appreciated that, although specific embodiments have been discussed herein for purposes of illustration, various modifications may be made without deviating from the spirit and scope of the discussion herein. Accordingly, the systems and methods, etc., include such modifications as well as all permutations and combinations of the subject matter set forth herein and are not limited except as by the appended claims or other claim having adequate support in the discussion and figures herein.

1. A digital photo-video camera system comprising a camera housing containing a digital photo-video camera, wherein a camera housing outer surface of the camera housing consists essentially of a tactile camera user interface wherein all image-capture controls of the outer tactile camera user interface are tactile controls requiring mechanical manipulation by a proximate user to select different image capture functions.

2. The digital photo-video camera system of claim 2 wherein the camera housing outer surface consists solely of the tactile camera user interface wherein all image-capture controls of the outer tactile camera user interface are tactile controls.

3. The digital photo-video camera system of claim 1 or 2 wherein the tactile camera user interface comprises a plurality of depressable elements.

4. The digital photo-video camera system of claim 1 or 2 wherein the tactile camera user interface consists essentially of a toggle switch located on an upper surface of the camera housing outer surface.

5. The digital photo-video camera system of claim 1 or 2 wherein the outer tactile camera user interface consists essentially of a rotary tab switch and a depressable button.

6. The digital photo-video camera system of claim 5 wherein the rotary tab switch encircles the depressable button.

7. The digital photo-video camera system of claim 5 wherein the rotary tab switch is a three-position switch.

8. The digital photo-video camera system of claim 1 or 2 wherein the tactile camera user interface comprises a three-position switch.

9. The digital photo-video camera system of claim 8 wherein the three-position switch comprises 1) an off position configured to turn off all proximity user-operated functions of the camera; 2) a photo position configured to permits user-acquisition of still photographs; and 3) an image capture position configured to activate continuous image capture until the three-position switch is physically switched to one of the other positions.

10. The digital photo-video camera system of claim 9 wherein the off position is further configured to turn off all user-controlled functions of the camera including functions controlled by a proximate user or a remote entity.

11. The digital photo-video camera system of claim 9 wherein the photo position is further configured to activate internal elements of the camera such that the camera can communicate with remote entities.

12. The digital photo-video camera system of claim 9 wherein the image capture position is further configured to include photo image capture upon activation of a corresponding tactile user interface.

13. The digital photo-video camera system of claim 12 wherein the tactile camera user interface is a rotary tab switch and the corresponding tactile user interface is a depressible button.

14. The digital photo-video camera system of claim 13 wherein the rotary tab switch encircles the corresponding tactile user interface is a depressable button.

15. The digital photo-video camera system of claim 13 wherein the rotary tab switch and the depressable button are located on a rear surface of the camera housing outer surface.

16. The digital photo-video camera system of claim 1 or 2 wherein the outer surface of the camera housing and the tactile camera user interface comprise no display screens or light-emitting elements.

17. The digital photo-video camera system of claim 1 or 2 wherein the outer surface of the camera housing comprises light-emitting elements and/or display screens and wherein the camera system comprises a lights off switch configured to universally disable all light-emitting elements and/or display screens.

18. The digital photo-video camera system of claim 1 or 2 wherein the system further comprises haptic feedback configured to provide non-visual information to the user

19. The digital photo-video camera system of claim 18 wherein the haptic feedback indicates different switch positions of the tactile user interface.

20. The digital photo-video camera system of claim 18 wherein the haptic feedback comprises detents, vibrations or pulsed vibrations.

21. The digital photo-video camera system of claim 1 or 2 wherein the tactile user interface is configured to be operated by a single hand of a user without visual interaction by the user with the tactile user interface.

22. The digital photo-video camera system of claim 1 or 2 wherein the user interface comprises a single control switch structured to control at least the following operations of the camera: a) power on/power off; and b) a record images function.

23. The digital photo-video camera system of claim 22 wherein the power on/power off and the record images functions are simultaneously engaged upon activating the control switch.

24. The digital photo-video camera system of claim 22 the user interface comprises at least one recording activation element and the user interface is configured such that the camera can be set for a standby mode such that activating the recording activation element during the standby mode causes the camera to begin recording images.

25. The digital photo-video camera system of claims 22 wherein the control switch is a depressible button, a toggle switch, a rotary tab or a knob.

26. The digital photo-video camera system of claim 1 or 2 wherein all upper surfaces of the camera housing are low profile and smooth such that no upper surfaces of the housing pose a snag hazard and wherein the camera housing comprises a concave base surface contoured to match and attach directly to a convexly curved base substrate such that the connection between the camera housing and the convexly curved base substrate has no gaps that pose a snag hazard.

27. A method comprising manufacturing a digital photo-video camera system according to claim 1 or 2.

28. A method comprising using a digital photo-video camera system according to claim 1 or 2.
